(19) United States
(12) Patent Application Publication
(10) Pub. No.: US 2006/0032212 A1
(43) Pub. Date: Feb. 16, 2006

(54) Lightweight rocket engine combustion chamber and associated method

(75) Inventors: John R. Wooten, Simi Valley, CA (US); Clifford C. Bampton, Thousand Oaks, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/914,948

(22) Filed: Aug. 10, 2004

(51) Int. Cl. F02K 9/60

(52) U.S. Cl. 60/257; 60/266

(57) ABSTRACT

A lightweight rocket engine combustion chamber and an associated method are provided. In one embodiment of the present invention, the combustion chamber includes an inner liner defining an inlet and an outlet, and at least one bonding strip attached to the liner. The combustion chamber also includes a structural jacket bonded to the bonding strip.

### BACKGROUND OF THE INVENTION

1) Field of the Invention

The present invention relates to rocket engines and, more particularly, to a rocket engine having a lightweight combustion chamber, as well as an associated method.

2) Description of Related Art

The function of a rocket engine main combustion chamber is to contain the combustion process, accelerate the combustion products therefrom to a high velocity and exhaust the combustion products to create thrust. The combustion process occurs at very high temperatures typically at 5,000 to 6,000° F. and at high pressures of 1,000 to 4,000 psi. Therefore, it is desirable for the combustion chamber to have a combination of structural strength and an ability to efficiently dissipate heat. Generally, materials that have thermal conductive properties sufficiently high enough to dissipate the heat of combustion, such as copper, do not possess the structural strength to withstand the pressure of combustion. Therefore, combustion chambers are typically constructed of a combination of materials possessing good thermal conductivity and high structural strength.

Combustion chambers are often constructed of a strong structural jacket of steel and a thermally conductive inner liner of copper, or copper alloy. A manifold having coolant channels is defined between the structural jacket and the inner liner. The manifold allows liquid coolant to be circulated throughout the combustion chamber for additional heat dissipation. The inner surface of the liner defines a Venturi nozzle in which subsonic combustion gases are accelerated to supersonic speeds before exiting the combustion chamber. Manufacturing such combustion chambers is typically difficult due to the complex hourglass-shape of the Venturi nozzle and the manifold. Such manufacturing difficulties are further compounded by the use of different materials for the outer shell and inner liner.

In one method, the combustion chamber is serially constructed by building up a structural steel jacket around a monolithic inner liner of copper, or copper alloy. The liner is constructed from a roughly cylindrical copper shell which is worked into the Venturi shape including a neck and a pair of flared (bell-shaped) ends to promote combustion, as described above. Typically, a high density superalloy material, such as nickel, is then welded (e.g., tungsten-inert gas welding) around the liner to form the structural jacket. The structural jacket is generally brazed to the liner to support the combustion chamber during combustion of a propellant, as well as defining the manifold where coolant may enter and exit to dissipate heat from the combustion chamber. Typically, channels are defined in the liner such that coolant is dispersed along the liner when coolant is introduced into the manifold.

However, the superalloys employed with typical combustion chambers are dense, which increases the weight of the combustion chamber. The increased weight of such a combustion chamber has the effect of reducing the payload of the rocket, as well as decreasing the efficiency of aircraft employing the combustion chamber in a rocket engine.

Ultrasonic welding may be used for joining two workpieces, metal or non-metal, that are typically incapable of being joined to form a high strength attachment. For example, the workpieces may have metallurgical differences that render conventional attachment techniques unacceptable. Ultrasonic welding includes combining a static normal force and oscillating shearing (i.e., tangential) stresses to cause plastic deformation at the interface of the workpieces, which breaks up the oxide films and contaminants to promote good contact and a solid-state bond. The temperatures reached during ultrasonic welding of metals are typically below the melting temperature of the workpieces such that the workpieces are connected through pressure and high-frequency mechanical vibrations. Because ultrasonic welding is capable of joining workpieces manufactured of dissimilar materials, a unique combination of materials may be used to improve structural properties.

It would therefore be advantageous to provide a combustion chamber that may be fabricated with lightweight materials. In addition, it would be advantageous to provide a combustion chamber that is lightweight but also capable of supporting the loading endured during flight. Furthermore, it would be advantageous to provide a combustion chamber that is capable of efficiently dissipating heat.

### BRIEF SUMMARY OF THE INVENTION

The invention addresses the above needs and achieves other advantages by providing a combustion chamber that is fabricated of lightweight materials that improves the overall efficiency of rocket engines employing the combustion chamber. The combustion chamber includes a liner and a lightweight structural jacket that may be joined to form a high-strength joint despite metallurgical differences between the liner and the structural jacket.

In one embodiment of the present invention, a combustion chamber is provided. The combustion chamber includes an inner liner defining an inlet and an outlet, and at least one bonding strip attached (e.g., with ultrasonic welding) to the liner. The bonding strip may be, for example, a continuous strip of material circumferentially shaped about the inner liner to achieve a desired thickness. The combustion chamber also includes a structural jacket bonded to the bonding strip.

In various aspects of the present invention, the inner liner is copper, while the bonding strip and structural jacket are aluminum or titanium. The structural jacket may include an inlet manifold and an outlet manifold, and the combustion chamber may also include a plurality of channels defined in the inner liner such that coolant introduced into the inlet manifold is capable of traveling through the channel and exiting through the outlet manifold. In addition, the combustion chamber may include grooves defined in the inner liner, where the grooves are capable of promoting adhesion of the inner liner and the bonding strip.

In additional aspects, a respective bonding strip is attached proximate to the inlet and outlet of the inner liner. The structural jacket may, in turn, be bonded to each of the respective bonding strips. Furthermore, the structural jacket may include inlet and outlet manifolds, where a respective inlet and outlet manifold is positioned proximate to the inlet and outlet of the inner liner.

Another aspect of the present invention also includes a method for assembling a combustion chamber. The method includes providing an inner liner, such as a copper liner, defining an inlet and an outlet, and attaching (e.g., with ultrasonic welding) at least one bonding strip, typically formed of aluminum or titanium, to the inner liner. Prior to attaching the bonding strip to the inner liner, the bonding strip may be circumferentially shaped about the inner liner. The method also includes bonding a structural jacket, such as an aluminum or titanium jacket, to the bonding strip. The method may include forming a plurality of channels in the inner liner, and closing out the channels by brazing, liquid interface diffusion bonding, or electrodeposition. Additionally, the method may include forming a plurality of grooves in the inner liner prior to welding the bonding strip to the inner liner. The method may include welding a bonding strip proximate to the inlet and outlet of the inner liner, and bonding the structural jacket to each of the respective bonding strips.

In yet another aspect of the present invention, a combustion assembly is provided. The combustion assembly includes a combustion chamber, as described above, as well as an injector assembly attached to the combustion assembly. The injector assembly typically includes a propellant ignition device and an oxidizer ignition device.

Similarly, the present invention provides a method for providing thrust via a combustion chamber, where the combustion chamber includes a liner and a structural jacket. The method includes providing at least one bonding strip attached (e.g., with ultrasonic welding) to the inner liner, and bonding a structural jacket to the bonding strip. The method also includes injecting a coolant proximate to the inner liner, as well as injecting a propellant and an oxidizer proximate to an inlet of the inner liner. The oxidizer combusts the propellant to generate thrust through an outlet of the inner liner. In variations of the method, injecting the coolant may include injecting a coolant through an inlet manifold defined in the structural jacket, through a plurality of channels defined in the inner liner, and out of an outlet manifold defined in the structural jacket.

The present invention therefore provides a combustion chamber that is lightweight and capable of producing a high-strength joint between materials having metallurgical differences. In one embodiment, a lightweight structural jacket, manufactured from aluminum or titanium, may be joined to a copper liner, where the dissimilarities in the metals would typically prevent the liner and structural jacket from forming a structurally sufficient joint capable of withstanding the loading typically endured during combustion and propulsion. In one embodiment, the bonding strip is advantageously also a lightweight material that is ultrasonically welded to the outer surface of the liner. The bonding strip is circumferentially welded to the liner and may be welded in various thicknesses to accommodate a variety of combustion chambers. The lightweight materials aid in the efficiency of rocket engines for vehicles such as an aircraft.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a cross-sectional view of a combustion chamber according to one embodiment of the present invention;

FIG. 2 is a flowchart illustrating a method of assembling a combustion chamber according to one embodiment of the present invention;

FIG. 3 is a cross-sectional view of a combustion assembly according to one embodiment of the present invention; and

FIG. 4 is a flowchart illustrating a method of providing thrust via a combustion chamber according to one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

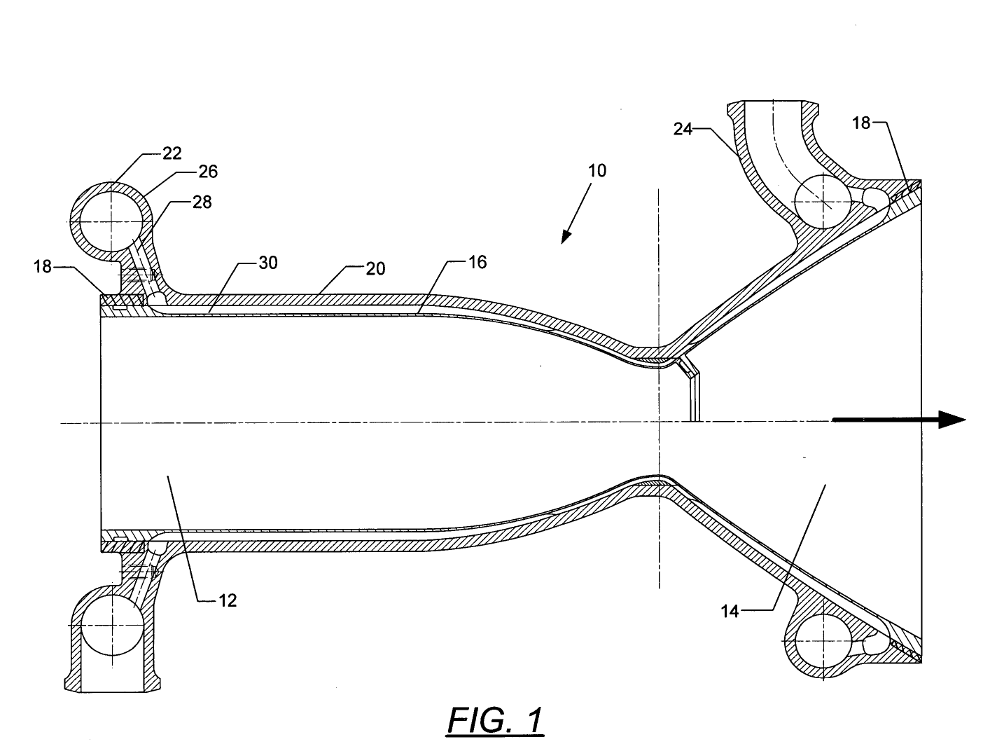

Referring now to the drawings and, in particular to FIG. 1, there is shown a combustion chamber 10 having an inlet 12 and an outlet 14. The combustion chamber 10 includes a liner 16 attached to bonding strips 18 proximate to the inlet 12 and outlet 14 of the liner. In one embodiment, the bonding strip 18 is ultrasonically welded to the inner liner 16. A structural jacket 20 is also bonded to the bonding strips 18 to secure the structural jacket to the liner 16. The bonding strip 18 advantageously enables a liner 16 and structural jacket 20 manufactured from dissimilar metals to be joined to form a high-strength joint.

As used herein, the term “combustion chamber” is not meant to be limiting and is typically a chamber where combustion and conversion of a propellant into kinetic energy occurs. The combustion chamber 10 is also generally configured into a nozzle to generate thrust through the chamber following combustion. In this regard, the combustion chamber 10 is any suitable chamber that is capable of withstanding the thermal, thrust, pressure, vibration and other dynamic loads generated during combustion of the propellant. Similarly, the term “combustion assembly” is not meant to be limiting and includes a combustion chamber and any suitable device(s) or method(s) for combusting a propellant in the combustion chamber. Therefore, the combustion chamber and combustion assembly are typically useful for rocket engines or similar engines requiring rocket propulsion, such as for an aircraft.

Although reference is made herein to ultrasonic welding, it is understood that other techniques to attach the bonding strip 18 and the inner liner 16 may be employed in alternative embodiments of the present invention. For example, brazing or friction stir welding could be used to attach or otherwise bond the bonding strip 18 and inner liner 16. Thus, references to ultrasonic welding are for illustrative purposes only, and are not meant to be limiting.

The inner liner 16 is generally configured into an inlet 12 where combustion of a propellant occurs, and an outlet 14 configured as a nozzle. The inner liner 16 generally includes a converging section, a constriction or throat, and a conical or bell-shaped diverging section. Hot gaseous products resulting from combustion of the propellant exit through the outlet 14 to generate thrust. The inner liner 16 is typically a high thermal conductivity material, such as copper or a copper alloy, that maintains strength at elevated temperatures. The high thermal conductivity material promotes heat removal from the combustion chamber when the combustion chamber employs a cooling mechanism, which typically includes an inlet manifold 22 and an outlet manifold 26 and manifold channels 28 and liner channels 30 for carrying the coolant therebetween.

The liner channels 30 are formed in the outer surface of the inner liner 16 and typically extend longitudinally in a direction parallel to the axis of the inner liner. However, the liner channels 30 can extend in other directions, such as helically about the inner liner 16, if so desired. The liner channels 30 typically are rectangular or circular in cross section, although various cross sections may be employed in alternative embodiments. There are a plurality of liner channels 30 defined in the outer surface of the inner liner 16 to provide an increased amount of heat transfer out of the inner liner and into the coolant flowing through the channels.

Similarly, there are a plurality of manifold channels 28 extending from the inlet 22 and outlet 24 manifolds such that each manifold channel is aligned with a respective liner channel 30. The manifold channels 28 may be arranged in any number of configurations, shapes, and sizes such that the manifold channels are capable of accommodating various liner channels 30. As such, as coolant enters the inlet manifold 24, coolant travels through the plurality of manifold channels 28 into a respective liner channel 30. Therefore, the coolant promotes removal of heat from the combustion chamber 10 through convection of the heat through the inner liner 16 to the coolant flowing through the liner channels 30 and manifold channels 28.

Although liner channels 30 have been discussed herein, it is understood that other cooling configurations may be used in alternative embodiments of the present invention, such as tubular chambers, as known to those skilled in the art. Thus, the tubular chambers could be brazed together into a coolant tube stack and secured to the inner liner 16 with an outer shell or with a stack of circumferential bands spaced along the length of the tube stack. For both liner channels 30 and tubular chambers, determining the number and configuration of coolant passages is an iterative process involving a variety of parameters, such as heat transfer, pressure loss, fabrication feasibility, and the geometry of the combustion chamber 10.

The structural jacket 20, as known to those skilled in art, is generally used as an external structural support capable of carrying thrust, pressure, thermal, vibration, and other dynamic loads. As shown in FIG. 1, the structural jacket 20 is contoured to closely approximate the contour of the inner liner 16, although the structural jacket may be any other size and configuration in alternative embodiments of the present invention. The structural jacket 20 is generally manufactured from a lightweight but structurally supportive material, such as aluminum or titanium.

Because the structural jacket 20 typically includes inlet 24 and outlet 26 manifolds positioned proximate to the fore and aft ends of the combustion chamber 10, it is usually necessary to attach the structural jacket to the inner liner 16 at the fore and aft ends. To facilitate this attachment, a bonding strip 18 is attached circumferentially about the inner liner 16. For example, a separate bonding strip 18 may be attached proximate to each of the fore and aft ends of the inner liner, as illustrated in FIG. 1. In one embodiment of the present invention, the bonding strip 18 is within the range of 0.004 to 0.007 inches in thickness, although it is understood that the bonding strip could be any desired thickness. The bonding strip 18 is advantageously a lightweight material that is capable of being ultrasonically welded, such as aluminum or titanium, that is bonded to the inner liner 16.

Although FIG. 1 illustrates a combustion chamber 10 suitable for regenerative cooling by utilizing a structural jacket 20 defining inlet 24 and outlet 26 manifolds, and an inner liner 16 defining liner channels 30, it is understood that various cooling techniques could be employed with the present invention in alternative embodiments. For example, techniques such as dump cooling, film cooling, transpiration cooling, ablative cooling, and radiation cooling, as all known to those skilled in the art, could be used in alternative embodiments of the present invention. It is also understood that combinations of cooling techniques may be used, for example, regenerative and radiation cooling. Moreover, the configuration of the combustion chamber 10 affects the hot gas film coefficient profile along the length of the chamber, which, in turn, influences the cooling method, as a variety of combustion chamber configurations defining different hot gas film coefficients may be used in alternative embodiments of the present invention.

Ultrasonic welding, as known to those skilled in the art, typically includes providing energy in the form of mechanical vibrations to fuse parts together. Specifically, a welding tool (i.e., a sonotrode) is typically coupled to one part and moves the part in a horizontal direction, while the other part remains static. The parts are then brought into contact such that the simultaneous static and dynamic forces cause the parts to weld together. The sonotrode may move with any of a variety of frequencies, and the forces applied between the parts to be welded vary depending on the thickness of the parts, surface structure, and their mechanical properties. A number of parameters, such as welding pressure or contact pressure, welding time, trigger point, amplitude of the sonotrode, and ultrasonic frequency, may be varied to accommodate different materials and desired welding properties. Ultrasonic welding produces a structurally sound joint between dissimilar metals that are typically otherwise incapable of being welded together. It has been demonstrated that ultrasonic welding promotes diffusion, which evidences that the metals have penetrated one another to form a solid and homogeneous joint.

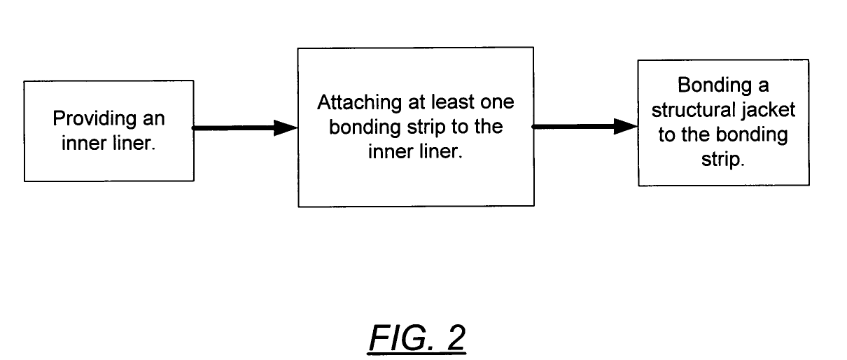

FIG. 2 illustrates a basic flowchart demonstrating that one or more bonding strips 18 are attached, such as with ultrasonic welding, to the inner liner 16. The structural jacket 20 is then bonded to each of the bonding strips 18 using a conventional technique, such as tungsten-inert gas welding. In additional embodiments of the present invention, the method includes forming a plurality of liner channels 30 in the inner liner 16 and then closing out the channels to allow coolant to flow through the channels. The liner channels 30 are typically “closed out” by electrodeposition, such as with copper or nickel, brazing, or liquid interface diffusion bonding, as all known to those skilled in the art. In embodiments where ultrasonic welding is employed, grooves or a similar configuration may be formed into the surface of the inner liner 16 adjacent to where the bonding strip 18 is welded to the inner liner to promote adhesion of the bonding strip to the inner liner during ultrasonic welding.

Each bonding strip 18 may be wrapped circumferentially about the inner liner 16 to achieve a predetermined thickness. Thus, the bonding strip 18 may be wrapped circumferentially about the inner liner 16 one or more revolutions. The bonding strip 18 may be ultrasonically welded to the inner liner 16 at a first end of the bonding strip and then wrapped about the inner liner and bonded at its opposite end with ultrasonic welding or another bonding technique. Alternatively, the bonding strip 18 could be ultrasonically welded continuously about the circumference of the inner liner 16 as the bonding strip is wrapped about the inner liner. Furthermore, multiple bonding strips 18 could be ultrasonically welded to the inner liner 16 in an overlapping relationship, rather than using a continuous strip to vary the thickness.

It is understood that the bonding strips 18 should not be limited to ultrasonic welding circumferentially about the inner liner 16, as the bonding strip could, for example, be welded to the inner liner partially about the circumference, or longitudinally along the axis of the inner liner in alternative embodiments of the present invention. In addition, it is understood that although the bonding strips 18 shown in FIG. 1 are welded proximate to the inlet 12 and outlet 14 of the inner liner 16, it is understood that the bonding strip could be ultrasonically welded to the inner liner at any desired location. In addition, it is understood that any number of bonding strips 18 may be bonded to the inner liner 16, and in a variety of configurations as described above.

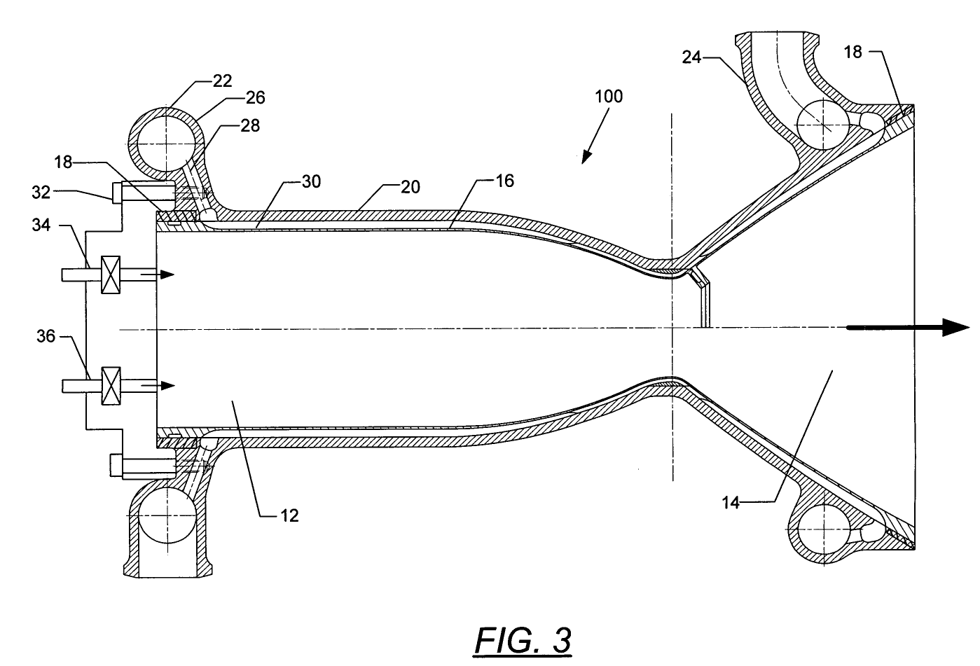

A combustion assembly 100 is shown in FIG. 3, where the combustion assembly includes a combustion chamber 10, as described above, as well as a propellant injector 34 and an oxidizer injector 36. The propellant injector 34, as known to those skilled in the art, uniformly injects propellant into the combustion chamber 10 as the oxidizer injector 36, as known to those skilled in the art, injects an oxidizer into the combustion chamber. Injecting the oxidizer causes the propellant to combust, which creates heat and pressure. The propellant 34 and oxidizer 36 injectors inject the propellant and oxidizer in predetermined fuel-to-oxidizer ratios to achieve a desired amount of thrust. The pressure is directed out of the outlet 14 to produce thrust. In this regard, the combustion assembly 100 is advantageous for applications, such as rocket engines used in aircraft or other vehicles.

The propellant 34 and oxidizer 36 injectors are typically attached to the combustion chamber 10 with fasteners 32, welding, and/or other techniques known to those skilled in the art. The propellant 34 and oxidizer 36 injectors typically include a respective valve that allows a predetermined amount of propellant and oxidizer to enter the combustion chamber 10, and the injectors also promote mixing and atomization of the propellant to more efficiently combust the propellant. In addition, the combustion assembly 100 generally includes an O-ring, or similar sealing device positioned between the propellant 34 and oxidizer 36 injectors and the combustion assembly 10 to prevent high pressure gases generated in the combustion chamber from flowing back towards the injectors. The propellant could be a liquid propellant, such as hydrogen, oxygen, ammonium, or hydrazine, which is a nitrogen/hydrogen compound. The oxidizer could be, for example, oxygen, air, or oxygen difluoride.

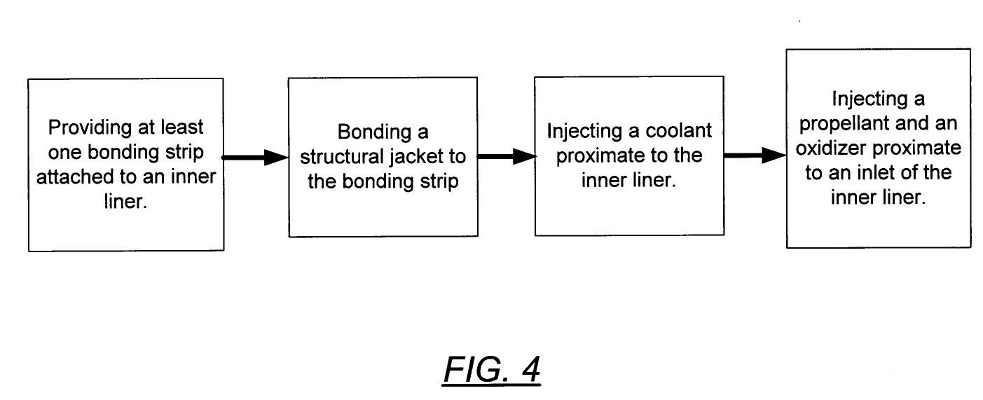

FIG. 4 illustrates a flowchart for providing thrust via a combustion chamber 10 using the combustion assembly 100 described above. Initially, a combustion chamber 10 having a bonding strip 18 attached to the inner liner 16, and a structural jacket 20 bonded to the bonding strip is provided, as described above. Typically, a propellant is injected with the propellant injector 34 proximate to the inlet 12 of the combustion chamber 10, and an oxidizer is injected with the oxidizer injector 16 to combust the propellant. The combustion of the propellant creates heat and pressure, where the pressure is directed out of the outlet 14 of the combustion chamber 10 to generate thrust. Because of the high temperatures generated during combustion of the propellant, it is advantageous to introduce a coolant within the inlet manifold 24 and through the liner channels 30 to transfer heat from the combustion chamber to the coolant. Coolant, such as liquid hydrogen, enters the inlet manifold 24 and is directed through the manifold channels 28 defined in the inlet manifold, travels through liner channels 30 defined in the inner liner 16, and then exits through the manifold channels defined in the outlet manifold 26.

Although FIGS. 3-4 demonstrate that the combustion assembly includes propellant 34 and oxidizer 36 injectors suitable for injecting a liquid propellant into the combustion chamber 10, it is understood that other techniques could be employed to inject and combust a propellant in the combustion chamber to generate thrust. For example, a gaseous monopropellant, such as Tridyne could be used in combination with a catalyst to combust the monopropellant in the combustion chamber 10. In addition, the combustion assembly 100 could employ a solid propellant, such that the propellant 34 and oxidizer 36 injectors are not required. The propellant could also be a combination of solid, liquid, or gaseous propellants, as known to those skilled in the art.

The cooling process described above with respect to FIGS. 3-4 is generally labeled regenerative cooling. In this regard, the coolant is typically also a propellant such that the coolant introduced into the inlet manifold 24, travels through the liner channels 30 to the outlet manifold 26 and is then introduced into the combustion chamber 10 to be utilized as a propellant. Thus, the coolant exiting the outlet manifold 26 may be used in conjunction with the propellant introduced by the propellant injector 34. However, as mentioned previously, alternative cooling techniques may be employed in alternative embodiments of the present invention, such that the coolant is not introduced as a propellant.

The combustion assembly 100 should not be limited to rocket engines utilizing chemical combustion with a propellant and oxidizer as described above, as the combustion assembly is capable of being employed with various types of sources of energy to generate combustion of the propellant, such as nuclear, solar, or electrical energy sources, as known to those skilled in the art. Similarly, different types and combinations of rocket engines may be employed with the combustion assembly 100, such as a combination of a ducted jet engine and a rocket engine. Therefore, the combustion chamber 10 and combustion assembly 100 are useful for a variety of rocket engines requiring propulsion.

The present invention therefore provides a combustion chamber 10 that is lightweight and capable of producing a high-strength joint between materials having metallurgical differences. Thus, a lightweight structural jacket 20 (e.g., manufactured from aluminum or titanium), may be joined to an inner liner 16 (e.g., manufactured from copper), where the dissimilarities in the metals would typically prevent the inner liner and structural jacket from forming a structurally sufficient joint capable of withstanding the loading typically endured during combustion and propulsion. In one embodiment, the bonding strip 18 is advantageously also a lightweight material that is ultrasonically welded to the outer surface of the inner liner 16. The bonding strip 18 is circumferentially welded to the inner liner 16 and may be welded in various thicknesses to accommodate a variety of combustion chambers 10. The lightweight materials aid in the efficiency of rocket engines for vehicles such as an aircraft.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A combustion chamber for containing and directing combustion of a propellant, the combustion chamber comprising:
an inner liner defining an inlet and an outlet;
at least one bonding strip attached to the liner; and
a structural jacket bonded to the bonding strip.

2. The combustion chamber according to claim 1, wherein the inner liner comprises copper.

3. The combustion chamber according to claim 1, wherein the bonding strip comprises one of aluminum and titanium.

4. The combustion chamber according to claim 1, wherein the structural jacket comprises one of aluminum and titanium.

5. The combustion chamber according to claim 1, wherein the structural jacket includes an inlet manifold and an outlet manifold.

6. The combustion chamber according to claim 5, further comprising a plurality of channels defined in the inner liner such that coolant introduced into the inlet manifold is capable of traveling through the channels and exiting through the outlet manifold.

7. The combustion chamber according to claim 1, further comprising grooves defined in the inner liner, the grooves capable of promoting adhesion of the inner liner and the bonding strip.

8. The combustion chamber according to claim 1, wherein the bonding strip comprises a strip of material circumferentially shaped about the inner liner.

9. The combustion chamber according to claim 1, wherein a respective bonding strip is attached proximate to the inlet and outlet of the inner liner.

10. The combustion chamber according to claim 9, wherein the structural jacket is bonded to each of the respective bonding strips.

11. The combustion chamber according to claim 9, wherein the structural jacket comprises inlet and outlet manifolds, and wherein a respective inlet and outlet manifold is positioned proximate to one of the inlet and outlet of the inner liner.

12. The combustion chamber according to claim 1, wherein the bonding strip is ultrasonically welded to the inner liner.

13. A method for assembling a combustion chamber comprising:
providing an inner liner defining an inlet and an outlet;
attaching at least one bonding strip to the inner liner; and
bonding a structural jacket to the bonding strip.

14. The method according to claim 13, further comprising shaping the bonding strip circumferentially about the inner liner.

15. The method according to claim 13, wherein attaching comprises attaching one of an aluminum and titanium bonding strip to a copper inner liner.

16. The method according to claim 15, wherein bonding comprises bonding one of an aluminum and titanium structural jacket to the bonding strip.

17. The method according to claim 13, further comprising forming a plurality of channels in the inner liner.

18. The method according to claim 17, further comprising closing out the channels with one of brazing, liquid interface diffusion bonding, and electrodeposition.

19. The method according to claim 13, further comprising forming a plurality of grooves in the inner liner prior to attaching the bonding strip to the inner liner.

20. The method according to claim 13, wherein attaching comprises attaching a bonding strip proximate to the inlet and outlet of the inner liner.

21. The method according to claim 20, wherein bonding comprises bonding the structural jacket to each of the respective bonding strips.

22. The method according to claim 13, wherein attaching comprises ultrasonically welding the bonding strip to the inner liner.

23. A combustion assembly comprising:
a combustion chamber comprising:
an inner liner defining an inlet and an outlet; and
at least one bonding strip attached to the liner; and
a structural jacket bonded to the bonding strip; and
an injector assembly attached to the combustion chamber.

24. The assembly according to claim 23, wherein the injector assembly comprises a propellant ignition device and oxidizer ignition device.

25. The assembly according to claim 23, wherein the bonding strip is ultrasonically welded to the inner liner.

26. A method for providing thrust to a combustion chamber, the combustion chamber comprising a liner and a structural jacket, the method comprising:
providing at least one bonding strip attached to the inner liner, and a structural jacket bonded to the bonding strip;
injecting a coolant proximate to the inner liner; and
injecting a propellant and an oxidizer proximate to an inlet of the inner liner, the oxidizer combusting the propellant to generate thrust through an outlet of the inner liner.

27. The method according to claim 26, wherein injecting a coolant comprises injecting a coolant through an inlet manifold defined in the structural jacket, through a plurality of channels defined in the inner liner, and through an outlet manifold defined in the structural jacket.

28. The method according to claim 26, wherein providing comprises providing a bonding strip ultrasonically welded to the inner liner.
